(19) United States
(12) Patent Application Publication
(10) Pub. No.: US 2026/0118491 A1
(43) Pub. Date: Apr. 30, 2026

(54) FMCW LASER MEASUREMENT METHOD AND SYSTEM

(71) Applicant: BEIJING MORELITE TECHNOLOGY CO. LTD., Beijing (CN)

(72) Inventors: Chunlin YANG, Beijing (CN); Banghong ZHANG, Beijing (CN); Mingzheng YANG, Beijing (CN); Tianbo SUN, Beijing (CN); Jie SUN, Beijing (CN)

(21) Appl. No.: 19/403,573

(22) Filed: Nov. 28, 2025

(30) Foreign Application Priority Data
Oct. 28, 2024 (CN) 202411512585.5

(51) Int. Cl. G01S 7/4913; G01S 17/58; G01S 17/931

(52) U.S. Cl. CPC G01S 7/4913; G01S 17/58; G01S 17/931

(57) ABSTRACT

This application provides a laser measurement method and system. The method includes: generating a frequency-swept light beam; splitting the frequency-swept light beam into a signal light beam and a local oscillator light beam; emitting the signal light beam and obtaining a reflected light beam; mixing the local oscillator light beam and the reflected light beam; acquiring a beat frequency electrical signal; sampling the beat frequency electrical signal to obtain a first sampled signal sequence; generating a complex signal sequence based on the first sampled signal sequence; sampling the complex signal sequence to obtain a second sampled signal sequence; and generating a target beat frequency based on the first sampled signal sequence and the second sampled signal sequence.

### CROSS-REFERENCE TO RELATED APPLICATION

The present disclosure claims a priority to Chinese Patent Application No. 202411512585.5 filed on Oct. 28, 2024, the disclosures of which are incorporated in their entirety by reference herein.

### TECHNICAL FIELD

The present disclosure relates to the field of laser measurement, and in particular, to a frequency-modulated continuous-wave (FMCW) laser measurement method and system.

### BACKGROUND

A frequency-modulated continuous-wave (FMCW) LiDAR obtains information such as the position (distance and angle) and motion state (velocity, vibration, and attitude) of a target object based on the beat frequency signal between a local oscillator signal and a reflected signal. When acquiring information such as the distance and velocity of the target object, the related distance measurement method requires performing Fast Fourier Transform (FFT) on the beat frequency signal. The distance measurement accuracy is limited by the sampling rate of the Fast Fourier Transform, making it impossible to achieve high-precision distance measurement.

### SUMMARY

In view of this, the present disclosure provides an FMCW laser measurement method and system to solve the technical problem that the related laser measurement methods are limited by the sampling rate of the Fast Fourier Transform and cannot achieve high-precision laser measurement.

In the first aspect, the present disclosure provides an FMCW laser measurement system, which comprises: a laser source configured to generate a frequency-swept light beam; an optical splitter configured to split the frequency-swept light beam into a signal light beam and a local oscillator light beam; an optical transceiver configured to emit the signal light beam and obtain a reflected light beam generated by the signal light beam on a target object; a mixer configured to perform mixing between the local oscillator light beam and the reflected light beam of the FMCW laser; a balanced detector configured to acquire a beat frequency electrical signal between the local oscillator light beam and the reflected light beam; a beat frequency acquirer configured to obtain the beat frequency electrical signal from the balanced detector; a first sampler configured to sample the beat frequency electrical signal to obtain a first sampled signal sequence; a complex exponential signal generator configured to generate a complex signal sequence based on the first sampled signal sequence; a second sampler configured to sample the complex signal sequence to obtain a second sampled signal sequence; a frequency synthesizer configured to generate a target beat frequency based on the first sampled signal sequence and the second sampled signal sequence.

Optionally, the FMCW laser measurement system further comprises a first Fourier transformer configured to perform a first Fast Fourier Transform on the first sampled signal sequence to obtain a first target frequency; wherein the complex exponential signal generator is configured to generate a complex exponential signal and multiply the complex exponential signal with the first sampled signal sequence to obtain the complex signal sequence.

Optionally, the FMCW laser measurement system further comprises a first low-pass filter configured to perform low-pass filtering on the complex signal sequence; wherein the second sampler is specifically configured to sample the complex signal sequence after low-pass filtering to obtain the second sampled signal sequence.

Optionally, the FMCW laser measurement system further comprises a second Fourier transformer configured to perform a second Fast Fourier Transform on the second sampled signal sequence to obtain a second target frequency.

Optionally, the frequency synthesizer is configured to add the first target frequency and the second target frequency to generate the target beat frequency.

In the second aspect, the present disclosure provides an FMCW laser measurement method, which comprises: generating a frequency-swept light beam; splitting the frequency-swept light beam into a signal light beam and a local oscillator light beam; emitting the signal light beam and obtaining a reflected light beam generated by the signal light beam on a target object; performing optical mixing between the local oscillator light beam and the reflected light beam; acquiring a beat frequency electrical signal between the local oscillator light beam and the reflected light beam of the FMCW laser; sampling the beat frequency electrical signal to obtain a first sampled signal sequence; generating a complex signal sequence based on the first sampled signal sequence; sampling the complex signal sequence to obtain a second sampled signal sequence; generating a target beat frequency based on the first sampled signal sequence and the second sampled signal sequence.

Optionally, the FMCW laser measurement method further comprises: before generating the complex signal sequence, performing a first Fast Fourier Transform on the first sampled signal sequence to obtain a first target frequency; wherein generating the complex signal sequence based on the first sampled signal sequence comprises: generating a complex exponential signal; multiplying the complex exponential signal with the first sampled signal sequence to obtain the complex signal sequence.

Optionally, the FMCW laser measurement method further comprises: before sampling the complex signal sequence, performing low-pass filtering on the complex signal sequence; sampling the complex signal sequence after low-pass filtering to obtain the second sampled signal sequence.

Optionally, the FMCW laser measurement method further comprises: performing a second Fast Fourier Transform on the second sampled signal sequence to obtain a second target frequency.

Optionally, the FMCW laser measurement method further comprises: adding the first target frequency and the second target frequency to generate the target beat frequency.

In the third aspect, the present disclosure provides an autonomous mobile device, which comprises the FMCW laser measurement system according to the first aspect above.

The solution of the present disclosure can improve the frequency resolution of the beat frequency signal and enhance the measurement accuracy of laser measurement without changing the modulation depth and the frequency-sweeping period.

### BRIEF DESCRIPTION OF THE DRAWINGS

FIG. 1 shows a structural schematic diagram of the continuous-wave LiDAR of the present disclosure;

FIG. 2A shows a schematic diagram of measuring a stationary object using an existing triangular-wave linear frequency-modulated continuous-wave LiDAR;

FIG. 2B shows a schematic diagram of measuring a moving object using an existing triangular-wave linear frequency-modulated continuous-wave LiDAR;

FIG. 3 shows a flowchart of the laser measurement method of the present disclosure;

FIG. 4A shows a structural schematic diagram of a LiDAR to which the laser measurement system of the present disclosure is applied;

FIG. 4B shows a structural schematic diagram of the laser measurement system of the present disclosure;

FIGS. 5A and 5B show schematic diagrams of an autonomous vehicle including the laser measurement system of the present disclosure.

### DETAILED DESCRIPTION

Hereinafter, specific implementations of the present disclosure will be described in detail with reference to the accompanying drawings. When the following description refers to the accompanying drawings, the same numbers in different drawings represent the same or similar elements unless otherwise indicated. In the following exemplary embodiments, the described implementations are not all implementations of the present disclosure. Instead, they are merely examples of devices and methods consistent with some aspects of the present disclosure as detailed in the appended claims. In the case of no conflict, the embodiments in the present disclosure and the features in the embodiments can be combined with each other.

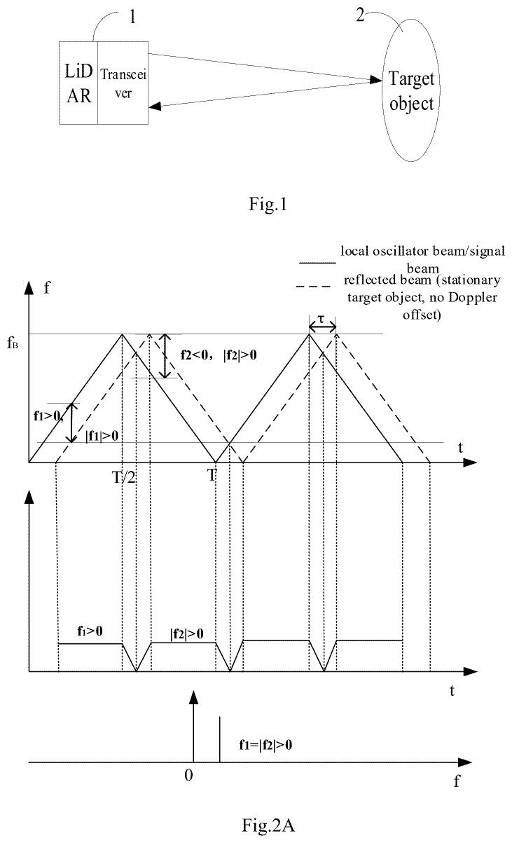

Referring to FIG. 1, FIG. 1 is a structural schematic diagram of the frequency-modulated continuous-wave (FMCW) laser measurement system of the present disclosure, the FMCW laser measurement system is a FMCW Light Detection And Ranging (LiDAR) device 1. The FMCW LiDAR 1 of the present disclosure adopts the working principle of coherent reception. By comparing the instantaneous beat frequency relationship between the reflected light beam reflected from the target object 2 and the local oscillator light beam of the LiDAR 1, information such as the distance between the target object 2 and the LiDAR 1 and the velocity of the target object can be provided simultaneously.

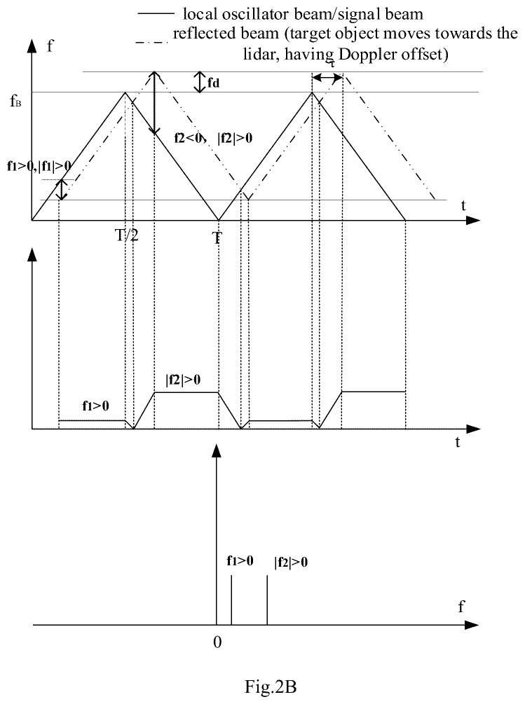

Referring to FIG. 2A, FIG. 2A shows a schematic diagram of measuring a stationary object using a related triangular-wave linear frequency-modulated FMCW LiDAR. In FIG. 2A, the solid triangular wave represents the instantaneous time-frequency relationship of the signal light beam or the local oscillator light beam of the LiDAR, and the dashed triangular wave represents the instantaneous time-frequency relationship of the reflected light beam from the stationary target object. Here, t is the delay of the reflected light beam from the stationary target object, f₁ and f₂ are the beat frequencies of the reflected light beam from the stationary object in the up-sweeping part and the down-sweeping part (i.e., the beat frequencies of the reflected light beam and the local oscillator light beam in the frequency-up phase and the frequency-down phase) respectively, T is a complete period formed by one up-sweeping and one down-sweeping, and f_{B} is the frequency-sweeping bandwidth (i.e., modulation depth) of the linear frequency modulation. In FIG. 2A, the beat frequencies of the reflected light beam in the frequency-up phase and the frequency-down phase are respectively:

$$\begin{matrix}{f}_{1} = \frac{2 {f}_{B}}{T} \frac{2 R}{c} \\ {f}_{2} = \frac{2 {f}_{B}}{T} \frac{2 R}{c}\end{matrix} \qquad Formula 1$$

Assuming the distance between the target object and the LiDAR is R, then R=τ*c/2, where c is the speed of light and A is the laser wavelength. In the time-frequency relationship diagram of FIG. 2A, the relationship between the beat frequencies of the reflected light beam in the frequency-up phase and the frequency-down phase and the distance between the target object and the LiDAR is as shown in Formula 2 below:

$$R = \frac{( {f}_{1} + {f}_{2} ) \cdot T \cdot c}{8 {f}_{B}} \qquad Formula 2$$

FIG. 2B shows a schematic diagram of measuring an object moving towards the LiDAR using a related triangular-wave modulated FMCW LiDAR. In FIG. 2B, the solid triangular wave represents the instantaneous time-frequency relationship of the signal light beam or the local oscillator light beam of the LiDAR, and the dashed triangular wave represents the reflected light beam from the target object moving towards the LiDAR. Here, t is the delay of the reflected light beam from the target object, f₁ and f₂ are the beat frequencies of the reflected light beam from the target object in the up-sweeping part and the down-sweeping part respectively, T is the period of the up-sweeping and the down-sweeping, f_{B} is the frequency-sweeping bandwidth of the linear frequency modulation, and f_{d}=(f2−f1)/2. In FIG. 2B, the beat frequencies of the reflected light beam in the frequency-up phase and the frequency-down phase are respectively:

$$\begin{matrix}{f}_{1} = \frac{2 {f}_{B}}{T} \frac{2 R}{c} - \frac{2 v}{λ} \\ {f}_{2} = \frac{2 {f}_{B}}{T} \frac{2 R}{c} + \frac{2 v}{λ}\end{matrix} \qquad Formula 3$$

The distance R and velocity v of the target object are as follows:

$$\{ \begin{matrix}R = \frac{( {f}_{1} + {f}_{2} ) \cdot T \cdot c}{8 {f}_{B}} \\ v = \frac{( {f}_{2} - {f}_{1} ) \cdot λ}{4}\end{matrix} \qquad Formula 4$$

When calculating the distance R and velocity v of the target object using Formula 2 and Formula 4 above, the beat frequency f₁ in the frequency-up phase and the beat frequency f₂ in the frequency-down phase are required. The beat frequency f₁ in the frequency-up phase and the beat frequency f₂ in the frequency-down phase are intermediate-frequency signals. When signal processing methods such as analog-to-digital conversion (ADC), discrete sampling, and Fast Fourier Transform (FFT) are used to process the beat frequency f₁ in the frequency-up phase and the beat frequency f₂ in the frequency-down phase, the resolution of the Fast Fourier Transform (FFT) determines the accuracy of the achievable frequency resolution. For example, when the sampling frequency is fₛ, the number of sampling points is N (N is a positive integer), and the sampling duration is T/2, the sampling time interval tₛ=1/fₛ, and the frequency resolution can be expressed as:

$$Δ f = \frac{{f}_{s}}{N} = \frac{1}{N \times {t}_{s}} = \frac{2}{T} \qquad Formula 5$$

The distance resolution can be expressed as:

$$Δ R = \frac{Δ f}{{f}_{B}} \times \frac{T \times c}{4} = \frac{c}{2 {f}_{B}} \qquad Formula 6$$

Therefore, the method for improving the distance measurement accuracy (i.e., reducing ΔR) can be realized by increasing f_{B} or reducing Δf. The present disclosure improves the distance measurement accuracy by reducing Δf without changing the modulation depth f_{B}.

In the present disclosure, frequency resolution refers to the ability to separate two adjacent spectral peaks on the frequency spectrum when performing Fourier Transform on the intermediate-frequency digital signal. In practical applications, it refers to the minimum interval for distinguishing two signals with different frequencies.

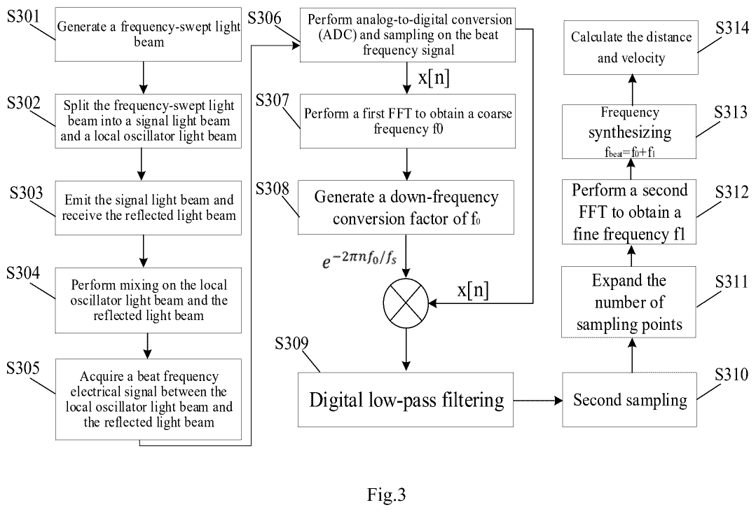

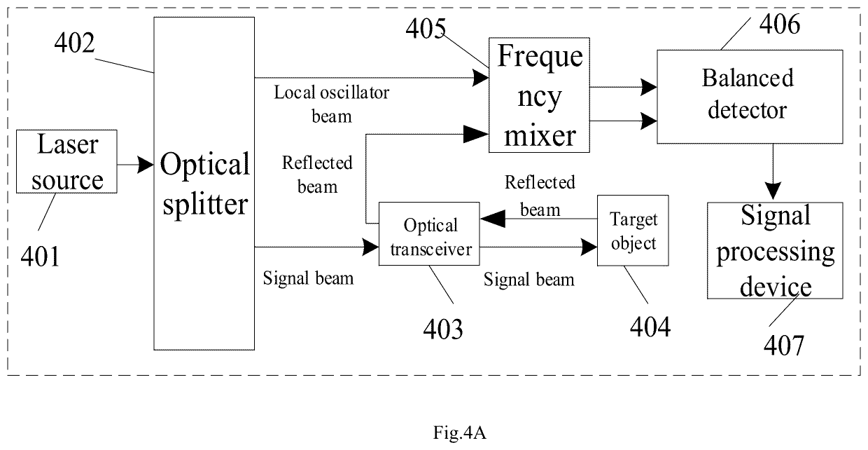

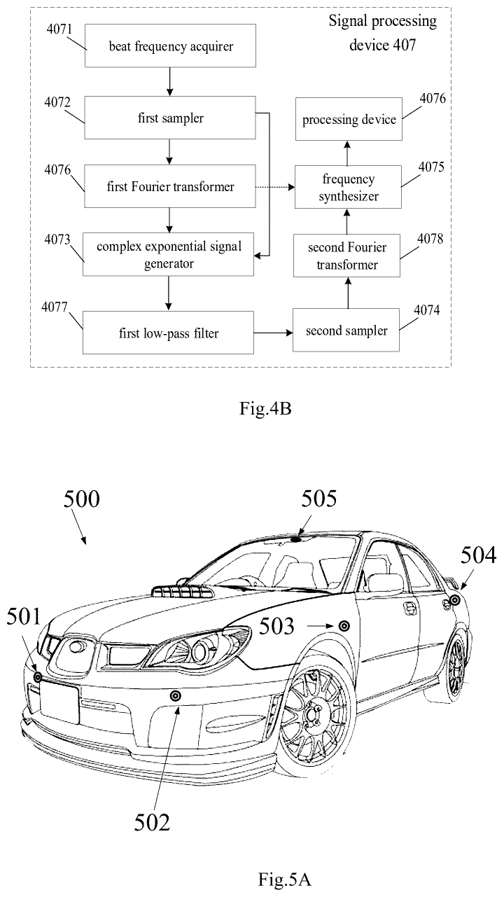

In some embodiments, the present disclosure provides a laser measurement method. This laser measurement method can be applied to a frequency-modulated continuous-wave (FMCW) LiDAR device. As shown in FIG. 3, the laser measurement method includes the following steps S301-S305.

Step S301: Generate a frequency-swept light beam.

Specifically, the frequency-swept light beam can be generated by a laser light source. The laser light source can be directly modulated by a chirp signal of the optical signal. For example, a driving signal controlling the laser light source can be input to the laser light source with an intensity that changes over time, so that the laser light source generates and outputs a frequency-swept light beam, i.e., a light beam whose frequency changes within a predetermined range.

In some embodiments, the laser light source may further include a modulator that receives a modulation signal. The modulator can be configured to modulate the light beam based on the modulation signal to generate and output a frequency-swept light beam. The frequency of the frequency-swept light beam changes within a predetermined range, and the frequency-swept light beam can have a triangular wave waveform or a sawtooth wave waveform, as shown in FIG. 2. The principle of generating a frequency-swept light beam by an FMCW LiDAR is well known to those skilled in the art. For the sake of brevity, it will not be further described herein.

Step S302: Split the frequency-swept light beam into a signal light beam and a local oscillator light beam.

In some examples, an optical splitter can be used to split the frequency-swept light beam into a signal light beam and a local oscillator light beam. The signal light beam and the local oscillator light beam have the same frequency at any time point, that is, the frequency modulation waveforms of the signal light beam and the local oscillator light beam are completely the same. In some examples, the optical splitter can be a specific wavelength coupler (optical splitter) for wavelengths ranging from 445 nm to 2100 nm, such as a 1×2 optical splitter on an optical chip and an optical splitter of the SMC series. In other examples, other optical splitters known to those skilled in the art that can split the frequency-swept light beam into a signal light beam and a local oscillator light beam can also be used.

Step S303: Emit the signal light beam and receive the reflected light beam generated by the signal light beam after encountering the target object.

In some examples, an optical transmitter and a receiver or an optical transceiver are used to emit the signal light beam at a predetermined angle, and the optical receiver or the optical transceiver is used to receive the reflected light beam reflected by the target object.

Step S304: Perform mixing on the local oscillator light beam and the reflected light beam to obtain an optical mixing signal between the local oscillator light beam and the reflected light beam.

Specifically, the received reflected light beam and the local oscillator light beam are subjected to optical mixing to obtain an optical mixing signal. An optical mixer can be used for optical mixing. The mixer can be a coupler, such as a 2×2 optical coupler, and the mixed signal is a coherent signal generated by the interference between the local oscillator light beam and the corresponding reflected light beam. The mixer or coupler can be a mixer and a coupler well known to those skilled in the art. For the sake of brevity, it will not be described in detail in the present disclosure.

Step S305: Acquire a beat frequency electrical signal between the local oscillator light beam and the reflected light beam.

Specifically, the beat frequency electrical signal may include electrical signals of the beat frequency in the frequency-up phase and the beat frequency in the frequency-down phase. The beat frequency signal in the frequency-up phase and the beat frequency signal in the frequency-down phase are intermediate-frequency signals.

Specifically, a balanced detector can be used to measure the beat frequency between the local oscillator light beam and the reflected light beam. The balanced detector can be a photoelectric detector.

Step S306: Perform analog-to-digital conversion (ADC) and sampling on the beat frequency signal in the frequency-up phase and the beat frequency electrical signal in the frequency-down phase to obtain a sampled sequence x[n].

Specifically, ADC and first sampling are performed on the beat frequency signal in the frequency-up phase and the beat frequency electrical signal in the frequency-down phase respectively to obtain a first sampled sequence X₁[n] and a second sampled sequence X₂[n]. In the present disclosure, the processing methods and principles for the first sampled sequence X₁[n] and the second sampled sequence X₂[n] are the same, and both will be described as the sampled sequence x[n] in the following description of the present disclosure.

In some examples, the sampling frequency of sampling is fₛ, and the number of sampling points is N, where N is a positive integer. Therefore, a sampled sequence x[n], n=0, 1, . . . , N-1 is obtained. In this case, the initial frequency resolution of the sampled signal is:

$$Δ f = \frac{{f}_{s}}{N} \qquad Formula 5$$

Step S307: Perform a first FFT on the sampled sequence x[n] to obtain a first target frequency f₀.

$${f}_{0} = a * Δ f , a ∈ ( 0 , N / 2 - 1 ) \qquad Formula 7$$

Specifically, the above first target frequency can be selected as the frequency center, and the frequency range that needs further processing can be selected as (f₀−Δf, f₀+Δf).

Step S308: Generate a unit complex exponential signal e^{-2πnf0/fs}, and multiply the unit complex exponential signal e^{-2πnf0/fs} with the sampled sequence x[n] to convert the real signal sequence into a complex signal sequence.

Specifically, by multiplying the unit complex exponential signal e^{-2πnf0/fs} with the sampled sequence x[n] (i.e., x[n]×e^{-2πnf0/fs}), the center frequency of the sampled signal is shifted from the first target frequency f₀ to the zero frequency.

Step S309: Perform low-pass filtering on the complex signal sequence using a low-pass anti-aliasing filter to filter out high-frequency components.

The specific content and parameters of the low-pass anti-aliasing filter can refer to related technologies, and will not be described in detail in the present disclosure. The parameters of the low-pass anti-aliasing filter can be designed according to actual needs. Optionally, the parameter design of the low-pass anti-aliasing filter needs to be able to filter out high-frequency components exceeding half of the sampling frequency.

Step S310: Perform second sampling on the complex signal sequence after low-pass filtering to obtain a new signal sequence X_{c}(n), n=0, 1, . . . , (N/M)-1.

Specifically, the sampling frequency of the second sampling can be fₛₓ=fₛ/M, where M=1, 2, 4, . . . , 2^{m}. Here, M is the multiple for frequency refinement of the complex signal sequence after low-pass filtering according to needs. M can be an integer multiple of 2 (i.e., M=1, 2, 4, . . . , 2^{m}), that is, the value of M can be selected, so that the frequency resolution is refined by M times, thereby improving the detectable distance resolution of the FMCW LiDAR by M times (see Formula 6). The new signal sequence x_{c}(n) obtained after the second sampling includes N/M discrete signals.

Step S311: Expand the N/M discrete signals to increase the number of sampling points to N.

Specifically, methods such as interpolation or zero-padding can be used to supplement sampling points for the N/M discrete signals. The interpolation and zero-padding methods can refer to the interpolation or zero-padding methods used by those of ordinary skill in the digital signal processing field. The frequency resolution of the N discrete signals after expansion is:

$$Δ {f}_{x} = {f}_{sx} / N = Δ f / M \qquad Formula 8$$

Step S312: Perform a second FFT on the expanded N discrete signals to obtain a second target frequency f₁.

Wherein, f₁=b*Δfx, and b is an integer in (−M, M).

Step S313: Add the first target frequency f₀ and the second target frequency f₁ to obtain a refined target signal frequency f_{beat}.

$${f}_{beat} = {f}_{0} + {f}_{1} = a Δ f + b Δ {f}_{x} = ( a * M + b ) * Δ {f}_{x} \qquad Formula 9$$

Step S314: Calculate the distance and velocity of the target object using the obtained refined target frequency f_{beat} according to Formula 3 and Formula 4.

Through the above method, the frequency spectrum resolution is refined by M times, and the distance measurement resolution is improved by M times. The solution of the present disclosure can improve the frequency resolution of the beat frequency signal and enhance the calculation accuracy of distance measurement without changing the modulation depth and the frequency-sweeping period.

FIG. 4A shows a structural schematic diagram of the FMCW LiDAR of the present disclosure. In this embodiment, the LiDAR includes a laser light source 401 configured to generate a frequency-swept light beam, which can be a frequency-swept light beam with a triangular wave waveform or a sawtooth wave waveform; and an optical splitter 402 configured to split the frequency-swept light beam into a signal light beam and a local oscillator light beam.

Specifically, the laser light source 401 can be directly modulated by a chirp signal of the optical signal. For example, the driving signal controlling the laser source 401 can be input to the laser light source 401 with an intensity that changes over time, so that the laser light source 401 generates and outputs a frequency-swept light beam, i.e., a light beam whose frequency changes within a predetermined range. The laser light source 401 may further include a modulator that receives a modulation signal. The modulator can be configured to modulate the light beam based on the modulation signal to generate and output a frequency-swept light beam, and the frequency of the frequency-swept light beam changes within a predetermined range. The laser light source 401 can be a common laser source in an FMCW LiDAR. For the sake of brevity, it will not be described in detail in the present disclosure.

The optical splitter 402 is configured to split the frequency-swept light beam into a signal light beam and a local oscillator light beam. The signal light beam and the local oscillator light beam have the same frequency at any time point, that is, the frequency modulation waveforms of the signal light beam and the local oscillator light beam are completely the same. In some examples, the optical splitter 402 can be a specific wavelength coupler (optical splitter) for wavelengths ranging from 445 nm to 2100 nm, such as an optical splitter of the SMC series. In other examples, other optical splitters known to those skilled in the art that can split the frequency-swept light beam into a signal light beam and a local oscillator light beam can also be used.

The LiDAR further includes: an optical transceiver 403 configured to emit the signal light beam and receive the reflected light beam generated by the signal light beam after encountering the target object 404; a mixer 405 configured to couple the local oscillator light beam and the reflected light beam and output the coupled light beam to a balanced detector 406; a balanced detector 406 configured to detect and acquire electrical signals of the beat frequency in the frequency-up phase and the beat frequency in the frequency-down phase between the local oscillator light beam and the reflected light beam, and output the acquired beat frequency electrical signal to a signal processing device 407; and a signal processing device 407 configured to refine the beat frequency to obtain a refined target beat frequency.

Referring to FIG. 4B, the signal processing device 407 specifically includes: a beat frequency acquirer 4071 configured to acquire the beat frequency electrical signal between the local oscillator light beam and the reflected light beam of the FMCW LiDAR from the balanced detector 406; a first sampler 4072 configured to sample the beat frequency electrical signal to obtain a first sampled signal sequence x[n]; a complex exponential signal generator 4073 configured to generate a complex signal sequence x[n]×e^{-2πnf0/fs} based on the first sampled signal sequence x[n]; a second sampler 4074 configured to sample the complex signal sequence x[n]×e^{-2πnf0/fs} to obtain a second sampled signal sequence X_{c}(n), n=0, 1, . . . , (N/M)-1; a frequency synthesizer 4075 configured d to generate a target beat frequency f_{beat}=f₀+f₁=aΔf+bΔfₓ=(a*M+b)*Δfₓ based on the first sampled signal sequence and the second sampled signal sequence.

Optionally, the signal processing device 407 further includes a first Fourier transformer 4076 configured to perform a first Fast Fourier Transform on the first sampled signal sequence x[n] to obtain a first target frequency f₀; wherein the complex exponential signal generator 4073 is configured to generate a complex exponential signal e^{-2πnf0/fs} and multiply the complex exponential signal e^{-2πnf0/fs} with the first sampled signal sequence x[n] to obtain the complex signal sequence x[n]×e^{-2πnf0/fs}.

Optionally, the signal processing device 407 further includes a first low-pass filter 4077 configured to perform low-pass filtering on the complex signal sequence x[n]×e^{-2πnf0/fs}, wherein the second sampler 4074 is specifically configured to sample the complex signal sequence x[n]×e^{-2πnf0/fs} after low-pass filtering to obtain the second sampled signal sequence X_{c}(n).

Optionally, the signal processing device 407 further includes a second Fourier transformer 4078 configured to perform a second Fast Fourier Transform on the second sampled signal sequence X_{c}(n) to obtain a second target frequency f1, where f₁=b*Δfₓ and b∈(−M, M).

Optionally, the frequency synthesizer 4075 is configured to add the first target frequency f₀ and the second target frequency f₁ to generate the target beat frequency f_{beat}=f₀+f₁=aΔf+bΔfₓ=(a*M+b)*Δfₓ, where a∈(0, N/2-1).

Optionally, the signal processing device 407 further includes a processing device 4076 configured to obtain the target beat frequency f_{beat} from the frequency synthesizer 4075 and calculate the distance and velocity of the target object using the target beat frequency f_{beat}.

The device of the present disclosure can implement the relevant steps of the above method embodiments, and reference can be made to the relevant descriptions of the above method for the same descriptions. For the sake of brevity, they will not be repeated herein.

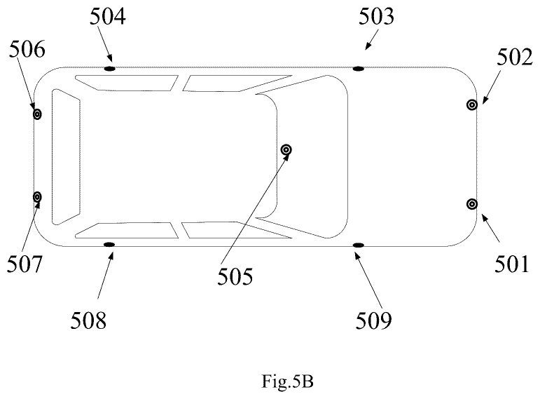

FIGS. 5A and 5B illustrate an exemplary autonomous vehicle 500 according to an embodiment of the present disclosure, which may include any component of the Light Detection And Ranging (LiDAR) device shown in FIG. 4 of the present disclosure. The shown autonomous vehicle 500 includes a sensor array configured to capture one or more objects in the external environment of the autonomous vehicle and generate sensor data related to the captured one or more objects for controlling the operation of the autonomous vehicle 500. FIG. 17 shows sensors 501, 502, 503, 504, and 505. FIG. 5A illustrates sensors 501, 502, 503, 504, 505, 506, 507, 508, and 509. FIG. 5B shows a top view of the autonomous vehicle 500. Any one of the sensors 501, 502, 503, 504, 505, 506, 507, 508, and 509 may include the LiDAR device shown in FIG. 4 of the present disclosure, which includes any LIDAR component in FIG. 4. The autonomous vehicle may include a powertrain including a prime mover powered by an energy source and capable of providing power to the transmission system. The autonomous vehicle may further include a control system including direction control, powertrain control, and brake control. The autonomous vehicle can be implemented as any number of different vehicles, including vehicles capable of transporting people and/or goods and capable of traveling in various different environments. It should be understood that the above components can vary widely based on the type of vehicle in which these components are used.

For the detailed content of this embodiment of the present disclosure, reference can be made to the description of the foregoing method embodiment. To avoid repetition, the present disclosure will not repeat the description herein.

Those of ordinary skill in the art can realize that the units and algorithm steps of the examples described in conjunction with the embodiments disclosed herein can be implemented by electronic hardware or a combination of computer software and electronic hardware. Whether these functions are implemented in hardware or software depends on the specific application and design constraints of the technical solution. Skilled artisans can use different methods for each specific application to implement the described functions, but such implementation should not be considered beyond the scope of the present disclosure.

What is claimed is:

1. A frequency-modulated continuous-wave (FMCW) laser measurement system, wherein the FMCW laser measurement system comprises:
a laser source configured to generate a frequency-swept light beam;
an optical splitter configured to split the frequency-swept light beam into a signal light beam and a local oscillator light beam;
an optical transceiver configured to emit the signal light beam and obtain a reflected light beam generated by the signal light beam on a target object;
a mixer configured to perform mixing between the local oscillator light beam and the reflected light beam;
a balanced detector configured to acquire a beat frequency electrical signal between the local oscillator light beam and the reflected light beam;
a beat frequency acquirer configured to obtain the beat frequency electrical signal from the balanced detector;
a first sampler configured to sample the beat frequency electrical signal to obtain a first sampled signal sequence;
a complex exponential signal generator configured to generate a complex signal sequence based on the first sampled signal sequence;
a second sampler configured to sample the complex signal sequence to obtain a second sampled signal sequence;
a frequency synthesizer configured to generate a target beat frequency based on the first sampled signal sequence and the second sampled signal sequence.

2. The FMCW laser measurement system according to claim 1, wherein the FMCW laser measurement system further comprises:
a first Fourier transformer configured to perform a first Fast Fourier Transform (FFT) on the first sampled signal sequence to obtain a first target frequency;
wherein the complex exponential signal generator is configured to generate a complex exponential signal and multiply the complex exponential signal with the first sampled signal sequence to obtain the complex signal sequence.

3. The FMCW laser measurement system according to claim 2, wherein the FMCW laser measurement system further comprises:
a first low-pass filter configured to perform low-pass filtering on the complex signal sequence;
wherein the second sampler is specifically configured to sample the complex signal sequence after low-pass filtering to obtain a second sampled signal sequence.

4. The FMCW laser measurement system according to claim 3, wherein the FMCW laser measurement system further comprises:
a second Fourier transformer configured to perform a second Fast Fourier Transform on the second sampled signal sequence to obtain a second target frequency.

5. The FMCW laser measurement system according to claim 4, wherein the frequency synthesizer is configured to add the first target frequency and the second target frequency to generate a target beat frequency.

6. A frequency-modulated continuous-wave (FMCW) laser measurement method, wherein the FMCW laser measurement method comprises:
generating a frequency-swept light beam;
splitting the frequency-swept light beam into a signal light beam and a local oscillator light beam;
emitting the signal light beam and obtaining a reflected light beam generated by the signal light beam on a target object;
performing optical mixing between the local oscillator light beam and the reflected light beam;
acquiring a beat frequency electrical signal between the local oscillator light beam and the reflected light beam;
sampling the beat frequency electrical signal to obtain a first sampled signal sequence;
generating a complex signal sequence based on the first sampled signal sequence;
sampling the complex signal sequence to obtain a second sampled signal sequence;
generating a target beat frequency based on the first sampled signal sequence and the second sampled signal sequence.

7. The FMCW laser measurement method according to claim 6, wherein the FMCW laser measurement method further comprises:
before generating the complex signal sequence, performing a first Fast Fourier Transform on the first sampled signal sequence to obtain a first target frequency;
wherein generating the complex signal sequence based on the first sampled signal sequence comprises:
generating a complex exponential signal;
multiplying the complex exponential signal with the first sampled signal sequence to obtain the complex signal sequence.

8. The FMCW laser measurement method according to claim 6, wherein the FMCW laser measurement method further comprises:
before sampling the complex signal sequence, performing low-pass filtering on the complex signal sequence;
sampling the complex signal sequence after low-pass filtering to obtain the second sampled signal sequence.

9. The FMCW laser measurement method according to claim 8, wherein the FMCW laser measurement method further comprises:
performing a second Fast Fourier Transform on the second sampled signal sequence to obtain a second target frequency.

10. The FMCW laser measurement method according to claim 9, wherein the FMCW laser measurement method further comprises:
adding the first target frequency and the second target frequency to generate the target beat frequency.
